(19) United States
(12) Patent Application Publication
(10) Pub. No.: US 2010/0195525 A1
(43) Pub. Date: Aug. 5, 2010

(54) Preliminary Neighbor Cell Suitability Check

(75) Inventor: Lauri Johannes Eerolainen, Paimio (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/679,606

(22) PCT Filed: Sep. 25, 2008
(86) PCT No.: PCT/IB2008/053917

§ 371 Date: Mar. 23, 2010

Related U.S. Application Data
(60) Provisional application No. 60/995,554, filed on Sep. 27, 2007.

(51) Int. Cl. H04L 12/26

(52) U.S. Cl. 370/252

(57) ABSTRACT

Disclosed herein are apparatus, method, and computer program product whereby user equipment (10) sends a serving base station an identification of at least one other base station (6A). The user equipment receives an indication from the serving base station that the serving base station does have or does not have an interface with the other base stations detected (6B). If the indication indicates that the serving base station does have an interface with a particular other base station, the user equipment populates one of a neighbor list or a candidate list with the identification of the particular—other base station (5B). If the indication indicates that the serving base station does not have an interface with a particular other base station, the user equipment populates a barred list with the identification of the particular other base station (5C).

### TECHNICAL FIELD

The exemplary and non-limiting embodiments of this invention relate generally to wireless communication systems, methods, devices and computer program products and, more specifically, relate to techniques related to neighbor cell measurement and handover procedures.

### BACKGROUND

Various abbreviations that appear in the specification and/or in the drawing figures are defined as follows:
2G 2nd generation mobile communication system, e.g. GSM
3G 3rd generation mobile communication system, e.g. WCDMA
3.9G advanced 3rd generation mobile communication system, e.g. EUTRAN
AGW access gateway
BCCH broadcast control channel
BCH broadcast channel
EUTRAN evolved universal terrestrial radio access network
LTE long term evolution
MAC medium access control
MME mobility management entity
NCC network color code
NodeB base station
eNB evolved NodeB (eNodeB)
NW network
OFDMA orthogonal frequency division multiple access
PDPC packet data convergence protocol
PHY physical layer
PLMN public land mobile network
PSI primary system information
RLC radio link layer
RRC radio resource control
S1 interface between eNodeB and AGW
SAE system architecture evolution
SC-FDMA single carrier, frequency division multiple access
TTI transmit time interval (in LTE 1 ms)
UE user equipment
UPE user plane entity
X2 interface between eNodeBs

A communication system known as evolved UTRAN (E-UTRAN, also referred to as UTRAN-LTE or as E-UTRA) is under development within the 3GPP. As presently specified The current working assumption is that the DL access technique will be OFDMA, and the UL access technique will be SC-FDMA.

One specification of interest to these and other issues related to the invention is 3GPP TS 36.300, V8.1.0 (2007-06), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8).

FIG. 1 herein reproduces FIG. 4 of 3GPP TS 36.300, V8.1.0 (2007-06) and shows the overall architecture of the E-UTRAN system. The E-UTRAN contains eNBs, providing the E-UTRA user plane (PDCP/RLC/MAC/PHY) and control plane (RRC) protocol terminations towards the UE. The eNBs are interconnected with each other by means of the X2 interface. The eNBs are also connected by means of the S1 interface to the EPC (Evolved Packet Core), more specifically to the MME (Mobility Management Entity) by means of the S1-MME and to the SAE Gateway by means of the S1-U. The S1 interface supports a many-to-many relation between MMEs/SAE Gateways and eNBs.

A concept that is pertinent to the description of the exemplary embodiments of this invention that is presented below is a neighbor cell suitability check. When a neighbor cell is detected (i.e., frequency and cell id) by the UE the suitability of the detected cell has to be defined before it can be selected to be a valid candidate for reselection/handover, depending on the situation. In conventional (non-EUTRAN) cellular systems the suitability check is performed by reading system information (SI) parameters from the neighbor cell.

In LTE, in order to make a handover, the X2 interface is used between the eNodeBs.

It should be noted that a handover of the UE without the use of the X2 interface could in theory be possible, but such a handover would be of an inter-PLMN handover type, where signaling would go via the AGW.

System information parameters are parameters that the network transmits in a periodic manner in predetermined and known channels (e.g., BCH). Such parameters may include, for example, power levels, neighbor lists, PLMN information and NW-specific parameters.

The reading of such system information parameters by the UE for use in the suitability check can take a relatively long period of time. For example, in LTE the primary system information (PSI) is repeated at 10 ms intervals. If one assumes that in the future it may be necessary for the UE to operate in a mode where it has to generate the neighbor list itself, the speed of execution of the suitability check becomes even more important. Particularly in the LTE ACTIVE mode (equivalent to the 2G Dedicated mode), where the data transfer rate may be high, it may become problematic for the UE to simultaneously scan for new neighbor cells, perform a suitability check for any newly detected neighbors, and still service an ongoing high data rate application.

In 3GPP TS 44.018, V8.0.0 (2007-09), Technical Specification 3rd Generation Partnership Project; Technical Specification Group GSM/EDGE Radio Access Network; Mobile radio interface layer 3 specification; Radio Resource Control (RRC) protocol (Release 8), section 10.5.2.27, there is introduced a “NCC permitted list” which is delivered in a serving cell “System Information 2” or “System Information 6”. The NCC from a neighbor cell can be defined during a synchronization process (i.e. no System information reading from the neighbor cell is needed). The purpose of the NCC permitted information element is to provide a definition of the allowed NCCs on the BCCH carriers to be reported in the measurement report by the mobile stations in the cell. The NCC Permitted information element is coded as shown in

FIG. 8 and FIG. 9. FIG. 8 herein reproduces FIG. 10.5.2.27.1 of 3GPP TS 44.018, V8.0.0 (2007-09) and FIG. 9 herein reproduces Table 10.5.2.27.1 of 3GPP TS 44.018, V8.0.0 (2007-09). The NCC permitted is a type 3 information element with 2 octets length.

The NCC parameter value is such that neighboring countries do not have the same value and. Thus, the NCC parameter can be used in country border areas to prevent the MS from evaluating those neighbors that are in the serving cell neighbor list, but yet are not from an “own” network. This may occur, for example, when a base station with the same frequency as an own-network neighbor base station can be heard from a neighboring country.

### SUMMARY

A first embodiment of the invention is a method comprising: sending a serving base station an identification of at least one other base station; receiving an indication from the serving base station that the serving base station does have or does not have an interface with the at least one other base station; in response to the indication indicating that the serving base station does have an interface with the at least one other base station, populating one of a first list or a second list with the identification of the at least one other base station; in response to the indication indicating that the serving base station does not have an interface with the at least one other base station, populating a third list with the identification of the at least one other base station.

Another embodiment of the invention is a method comprising: receiving a request from a user equipment at a particular base station, wherein the request contains identifications of base stations detected by the user equipment; sending the user equipment identifications of only those base stations that have an interface with the particular base station.

A further embodiment of the invention is a computer readable medium encoded with a computer program executable by a processor to perform actions comprising: sending a serving base station an identification of at least one other base station;

receiving an indication from the serving base station that the serving base station does have or does not have an interface with the at least one other base station; in response to the indication indicating that the serving base station does have an interface with the at least one other base station, populating one of a first list or a second list with the identification of the at least one other base station; in response to the indication indicating that the serving base station does not have an interface with the at least one other base station, populating a third list with the identification of the at least one other base station.

A still further embodiment of the invention is a computer readable medium encoded with a computer program executable by a processor to perform actions comprising: receiving a request from a user equipment at a particular base station, wherein the request contains identifications of base stations detected by the user equipment; sending the user equipment identifications of only those base stations that have an interface with the particular base station.

Another embodiment of the invention is an apparatus, comprising: a transmitter configured to send a serving base station an identification of at least one other base station; a receiver configured to receive an indication from the serving base station that the serving base station does have or does not have an interface with the at least one other base station; and a controller configured to respond to receipt of an indication that the serving base station does have an interface with the at least one other base station, to populate one of a first list or a second list with the identification of the at least one other base station; said controller further configured to respond to receipt of an indication that the serving base station does not have an interface with the at least one other base station, to populate a third list with the identification of the at least one other base station.

Another embodiment of the invention is an apparatus, comprising: a receiver configured to receive a request from a user equipment at a particular base station, wherein the request contains identifications of base stations detected by the user equipment; and a transmitter configured to send the user equipment identifications of only those base stations that have an interface with the particular base station.

### BRIEF DESCRIPTION OF THE DRAWINGS

In the attached Drawing Figures:

FIG. 1 reproduces FIG. 4 from 3GPP TS 36.300, V8.1.0 (2007-06) and shows the overall architecture of the E-UTRAN system.

FIG. 2 presents a logic flow diagram that expresses one suitable and non-limiting algorithm for generating a neighbor list based on X2 interface status.

FIG. 3 is an exemplary view of the EUTRAN architecture that is useful for explaining various use cases in accordance with the exemplary embodiments of this invention.

FIG. 4 shows a simplified block diagram of various electronic devices that are suitable for use in practicing the exemplary embodiments of this invention.

FIG. 5 is a logic flow diagram that shows a method, and the operation of a computer program, by the UE shown in FIGS. 3 and 4.

FIG. 6 is a logic flow diagram that shows a method, and the operation of a computer program, by the eNodeB shown in FIGS. 3 and 4.

FIG. 7 is a logic flow diagram that shows a method, and the operation of a computer program, by the UE shown in FIGS. 3 and 4.

FIG. 8 reproduces FIG. 10.5.2.27.1 from 3GPP TS 44.018, V8.0.0 (2007-09) and shows the NCC Permitted information element.

FIG. 9 reproduces Table 10.5.2.27.1 from 3GPP TS 44.018, V8.0.0 (2007-09) and shows the NCC Permitted information element.

### DETAILED DESCRIPTION

In current systems (e.g., 2G and 3G systems) the NW delivers the neighbor list to the UE. However, and as was noted above, in the future it may be desirable to have the UE build the neighbor list itself, as this would simplify NW planning. For example, plug-and-play low power private base stations could be readily attached to home/office environments. The exemplary embodiments of this invention provide methods, apparatus and computer programs that enable the UE to construct the neighbor list itself by utilizing at least in part an X2 interface status functionality of LTE.

It should be noted that the X2 interface status check may be used for a preliminary neighbor cell suitability check in LTE, even though a neighbor list was sent by the NW.

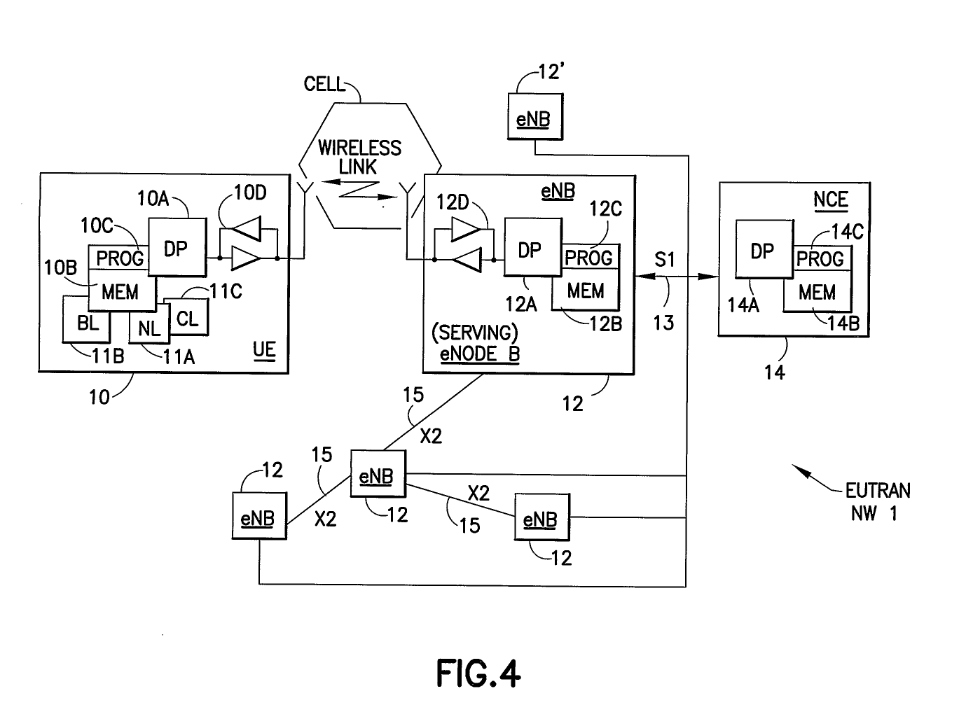

Reference is made first to FIG. 4 for illustrating a simplified block diagram of various electronic devices that are suitable for use in practicing the exemplary embodiments of this invention. In FIG. 4 a wireless network 1 (an EUTRAN NW) is adapted for communication with a UE 10 via an eNodeB (base station, also referred to herein as an eNB) 12. The NW 1 includes a network control element (NCE) 14, such as the AGW. The UE 10 includes a controller such as a data processor (DP) 10A, a memory (MEM) 10B that stores a program (PROG) 10C, and a suitable radio frequency (RF) transceiver 10D for bidirectional wireless communications with the eNodeB 12, which also includes a DP 12A, a MEM 12B that stores a PROG 12C, and a suitable RF transceiver 12D. The eNodeB 12 is coupled via an interface 13 (the S1 interface in this example) to the NCE 14 that also includes a DP 14A and a MEM 14B storing an associated PROG 14C. There are typically a plurality of eNBs 12 coupled together by interfaces 15 (X2 interfaces in this example), and each of these additional eNBs 12 of the NW 1 is coupled back to the NCE 14 via an S1 interface. Note that first eNB mentioned may be considered to be a currently serving eNB for the UE 10. Note also that there is shown another eNB 12′ that does not have an X2 interface with the serving eNB 12, although it may have an S1 interface with the NCE 14.

Also shown for the UE 10, as a part of the memory 10B, is a neighbor list (NL) 11A that is assumed to be constructed and populated with identifications of those cells found to be suitable cells (associated with other eNBs 12) by the UE 10, using the exemplary embodiments of this invention as described in detail below. Also shown is a barred list (BL) 11B, that stores identifications of cells found to be unsuitable for the UE 10. Also shown is a candidate list (CL) 11C that stores identifications of cells that are potential candidate cells to be included in the neighbor list 11A.

At least one of the PROGs 10C and 12C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNodeB 12, or by hardware, or by a combination of software and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

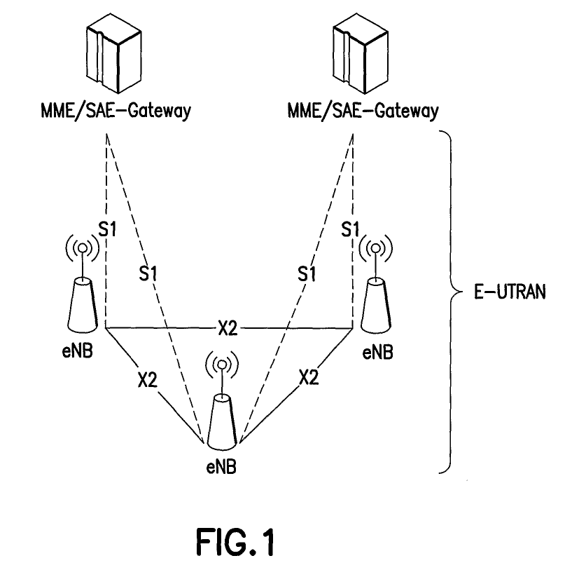

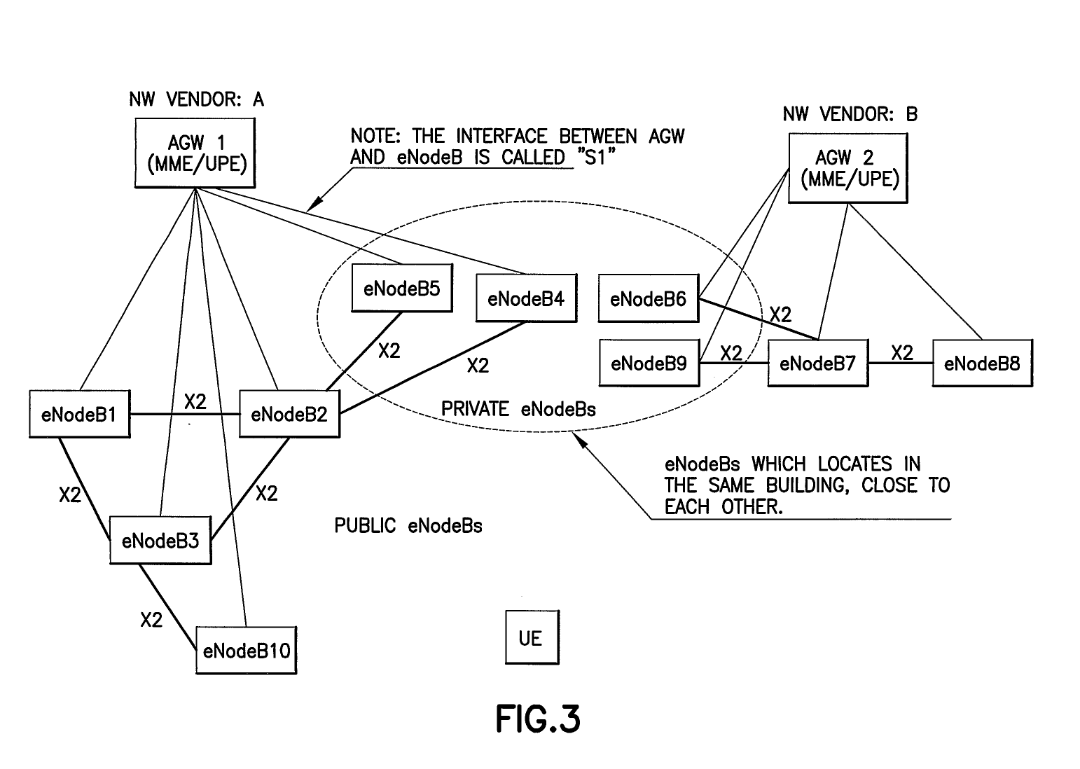

Reference can also be made to FIG. 3 for showing a more complex case (than FIGS. 1 and 4) where there are NWs A and B, as well as both public eNBs and private eNBs, such as those that may be located in the same building in close proximity to one another.

In accordance with the exemplary embodiments of this invention, when the UE 10 detects a new cell it requests from the serving eNodeB 12 the status of the X2 interface together with public/private information. In other words the UE 10 requests from the serving eNodeB 12 if it has an X2 interface with the candidate eNodeB 12 of the detected cell. Therefore, and from the point of view of the UE 10, a particular neighbor cell may have the following status:
A) X2 exists with the serving eNB 12 and it is public, and is therefore a reselection/handover candidate (meaning that the UE 10 can add this particular neighbor cell to the neighbor list 11A); or
B) X2 exists with the serving eNB 12 and it is private, indicating that it may be suitable for the UE 10 (meaning that a conventional suitability check should be performed); or
C) X2 does not exist with the serving eNB 12, indicating that the detected cell is a barred cell for the UE (since it is assumed that the X2 interface is used for handover in LTE).

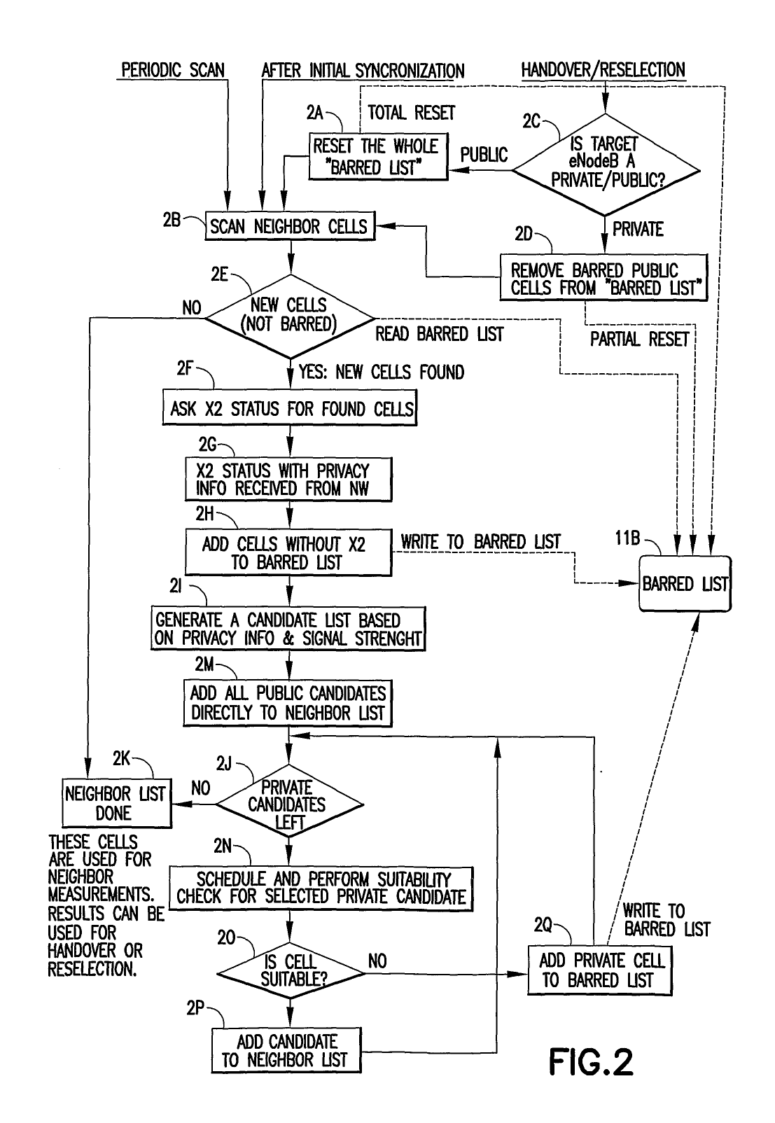

Several exemplary and non-limiting use cases are now described to further illustrate the foregoing principles: initial synchronization, handover from a private eNodeB to a public eNodeB and handover from a public eNodeB to a private eNodeB. The specific eNodeB references (e.g., eNodeB4, eNodeB6, etc.) are in reference to FIG. 3. One non-limiting example of an algorithm for defining the neighbor list 11A is shown in FIG. 2, and the operations therein labeled 2A-2Q can be referred to in conjunction with the discussion of the following exemplary use cases.

### Use Case: Initial Synchronization

A) The UE 10 is switched on nearby to eNodeB4 and eNodeB6.
B) The UE 10 begins to scan for cells.
C) The eNodeB6 is found and has the strongest cell.
D) The UE 10 attempts to perform registration, and the AGW2 rejects the registration (wrong network).
E) The eNodeB4 is found to be the next strongest candidate cell.
F) The UE 10 attempts to perform a registration, and the AGW1 accepts the registration (this was the private eNodeB of the UE 10.)
   Use Case: Handover from Private eNodeB to Public eNodeB
A) The UE 10 is camped on its private eNodeB4.
B) The UE 10 scans for neighbors (e.g., see block 2B of FIG. 2) and the following new eNodeBs are found: eNodeB2, eNodeB5, eNodeB9 and eNodeB10. Note that eNodeB6 is not treated as a new cell since during the initial synchronization (in this example) it was found to be unsuitable for the UE 10, i.e., the eNodeB6 was added to the barred list 11B during the initial synchronization procedure in Step D above.
C) The UE 10 requests the X2 status for eNodeB2, eNodeB5, eNodeB9 and eNodeB10 (e.g., see block 2F of FIG. 2).
D) The NW response indicates that eNodeB2: “public”. Note: X2 does not exist to eNodeB5, eNodeB9 and eNodeB10 from eNodeB4.
E) The UE 10 adds cells associated with eNodeB5, eNodeB9 and eNodeB10 to the barred list 11B (e.g., see blocks 2H, 2L of FIG. 2), and adds the cell associated with eNodeB2 to the neighbor list 11A because it is public (e.g., see block 2M of FIG. 2).
F) The UE 10 goes to the LTE ACTIVE mode.
G) The UE 10 measures and reports eNodeB2 and eNodeB 4 to the NW.
H) The UE 10 begins to move and the signal received from eNodeB2 begins to get stronger.
I) A handover command is sent to the UE 10 and the UE 10 changes to the cell of eNodeB2.
J) The LTE_ACTIVE mode continues in the new cell of eNodeB2, the scanning of neighbor cells begins, and the barred list 11B is reset.
   Use Case: Handover from Public eNodeB to Private eNodeB
A) The UE 10 is camped on the eNodeB2.
B) The UE 10 begins scanning for neighbors cells.
C) The UE 10 finds the eNodeB1, eNodeB3, eNodeB10, eNodeB5, eNodeB4, eNodeB6 and eNodeB9.
D) The UE 10 requests the X2 status of these eNodeBs, and the NW replies with eNodeB1:public; eNodeB3:public; eNodeB5:private and eNodeB4 private.
E) In response, the UE 10 adds eNodeB6, eNodeB9 and eNodeB10 to the barred list 11B (those eNodeBs for which no X2 status was returned (e.g., see blocks 2H and 2L of FIG. 2)).
F) The UE 10 populates the candidate list 11C (e.g., see block 21 of FIG. 2) based on privacy information and signal strength, for example:
a. Public: strongest, next strongest, . . . , last public with sufficient “criteria” to be a candidate
b. Private: strongest, next strongest, . . . , last private with sufficient “criteria” to be a candidate
G) The UE 10 adds public cells eNodeB1 and eNodeB3 to the neighbor list 11A and begins measuring (and reporting) them (e.g., see block 2M of FIG. 2).
H) The UE 10 schedules suitability checks for the private cell candidates in the order defined in the private candidate list 11C in Step Fb above (e.g., see block 2N of FIG. 2).
I) If a private cell is found not to be suitable, it is added to the barred list 11B (e.g., see blocks 2O, 2Q and 2L of FIG. 2).

J) If a private cell is found to be suitable, it is added to the neighbor list 11A and added into the measurement loop and is eventually reported to NW (e.g., see block 2P of FIG. 2).
K) Handover may be commanded to the eNodeB4, as it was found to be a private cell that is suitable for use by the UE 10.

There are various methods that may be used for making the X2 status query between the UE 10 and the NW. Those cell/cells for which the X2 status is requested could be delivered to the NW using, for example, measurement reports or, as a further non-limiting example, ACK/NACK messages. In the LTE_CONNECTED mode the suitability response (X2 status) may be received from the NW with, possibly, 2 TTI delay, i.e., within 2 ms.

It should be appreciated that a number of technical effects can be realized by the use of the exemplary embodiments of this invention. For example, the UE 10 is enabled to construct and maintain the neighbor list 11A on its own, without requiring that a neighbor list be downloaded to it from the NW. Further, when in the LTE_CONNECTED mode the suitability check can be resolved in 2 ms time (2xTTI) for a public cell, while a private cell would require a somewhat longer time (e.g., 10 ms, as a conventional technique can be used). Another technical effect is that the use of these exemplary embodiments simplifies the network planning requirements of the NW vendor/operator, and enables NW modifications to be more readily made.

Based on the foregoing it should be apparent that the exemplary embodiments of this invention provide a method, apparatus and computer program product(s) to enable a UE to autonomously construct and maintain a neighbor cell list.

Referring to FIG. 5, in accordance with an exemplary method the UE at Block 5A requests of a serving base station (the eNodeB 12) whether one or more other base stations detected by the UE have an interface (an X2 interface) with the serving base station; at Block 5B the UE uses the interface-related information received from the serving base station to populate one of a neighbor cell list or a candidate cell list with identifications of one or more other base stations indicated as having an interface to the serving base station and, at Block 5C, if no interface-related information is received from the serving base station for a particular one or more other base stations detected by the UE (indicating that the serving base station does not have an interface to the particular one or more other base stations), the UE populates a barred cell list with identifications of the particular one or more other base stations for which no interface-related information is received.

The method of the preceding paragraph, where the interface-related information comprises a base station identification and an indication of whether the base station is associated with a public network or a private network.

It should be further appreciated that the exemplary embodiments of this invention pertain to apparatus at the UE 10, which may be embodied as a transmitter, a receiver and means for requesting of a serving base station whether one or more other base stations detected by the UE 10 have an interface (an X2 interface) with the serving base station. The UE 10 further comprises means for using the interface-related information received from the serving base station for populating one of a neighbor cell list or a candidate cell list with identifications of one or more other base stations indicated as having an interface to the serving base station, said means being farther responsive to a case where no interface-related information is received from the serving base station for a particular one or more other base stations detected by the UE (indicating that the serving base station does not have an interface to the particular one or more other base stations), for populating a barred cell list with identifications of the particular one or more other base stations for which no interface-related information is received. The interface-related information, may comprise a base station identification and an indication of whether the base station is associated with a public network or a private network.

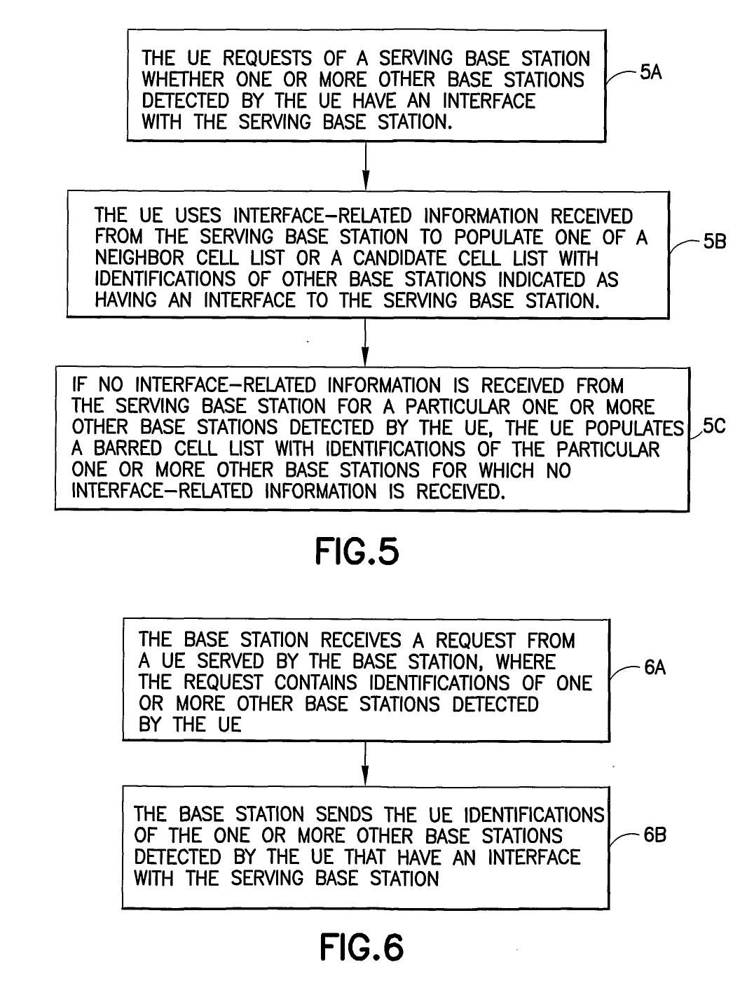

Referring to FIG. 6, in accordance with another exemplary method a base station (the eNodeB 12) at Block 6A receives a request from a UE served by the base station, where the request contains identifications of one or more other base stations detected by the UE; and in response, at Block 6B, the base station sends the UE identifications of the one or more other base stations detected by the UE that have an interface (an X2 interface) with the serving base station.

The method of the preceding paragraph, where the identifications of the one or more other base stations sent to the UE also include an indication of whether the base station is associated with a public network or a private network.

It should be further appreciated that the exemplary embodiments of this invention pertain to apparatus at the eNodeB 12, which may be embodied as a transmitter, a receiver and means responsive to a request received from a UE that is served by eNodeB, where the request contains identifications of one or more other base stations detected by the UE, for sending the UE identifications of the one or more other base stations detected by the UE that have an interface (an X2 interface) with the serving eNodeB. The identifications of the one or more other base stations sent to the UE may also include an indication of whether the base station is associated with a public network or a private network.

The various blocks shown in FIGS. 5 and 6 may be viewed as method steps, and/or as operations that result from operation of computer program code, and/or as a plurality of coupled logic circuit elements constructed to carry out the associated function(s).

It should be pointed out that while the preceding description has assumed that a lack of a response from the serving eNodeB 12 for a particular eNodeB detected by the UE 10 is interpreted by the UE 10 as indicating that there is no interface between the serving eNodeB 12 and the particular eNodeB, it is within the scope of this invention to send back a response to the UE 10 for each requested eNodeB, where the response for an eNodeB for which no interface exists may expressly indicate this condition to the UE 10 in some way. In general, it should be appreciated based on the foregoing description that the specific details of the signaling, including the content and format of the signaling between the UE 10 and the serving eNodeB 12, may be designed in many different ways. However, all of the various possible signaling techniques that may be used to implement the exemplary embodiments of this invention will fall within the scope of the exemplary embodiments of this invention.

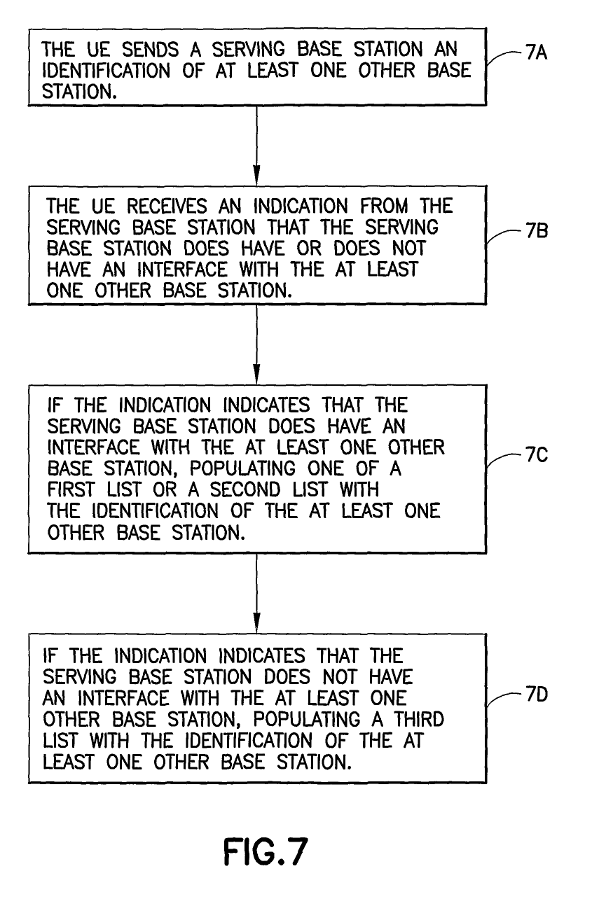

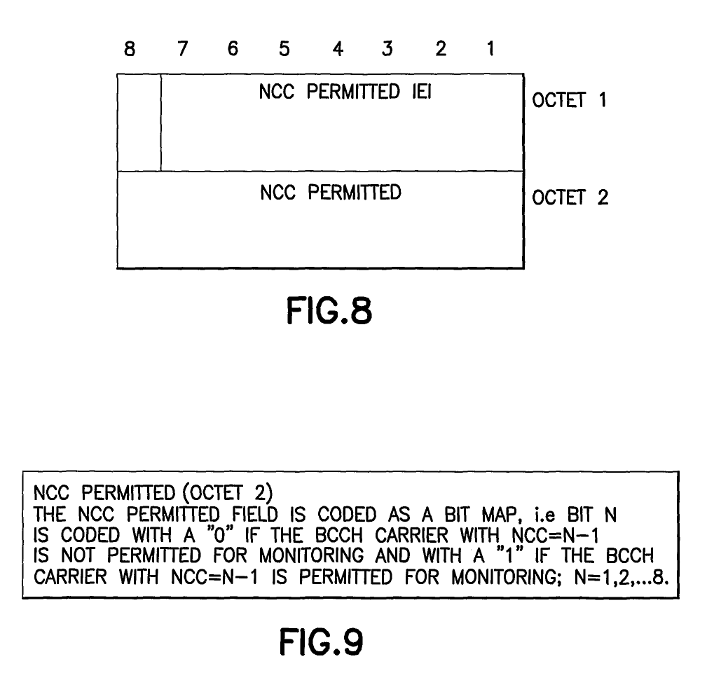

Referring to FIG. 7, in accordance with an exemplary method the UE at Block 7A sends a serving base station (the eNodeB 12) an identification of at least one other base station; at Block 7B the UE receives an indication from the serving base station that the serving base station does have or does not have an interface (an X2 interface) with the at least one other base station; at Block 7C, if the indication indicates that the serving base station does have an interface with the at least one other base station, populating one of a first list (neighbor list) or a second list (candidate list) with the identification of the at least one other base station; and at Block 7D, if the indication indicates that the serving base station does not have an interface with the at least one other base station, populating a third list (barred list) with the identification of the at least one other base station.

The method of the preceding paragraph, where the indication received comprises a base station identification and an indication of whether the base station is associated with a public network or a private network.

The blocks shown in FIG. 7 may be viewed as method steps, and/or as operations that result from operation of computer program code, and/or as a plurality of coupled logic circuit elements constructed to carry out the associated function(s).

It should be further appreciated that the exemplary embodiments of this invention pertain to apparatus at the UE 10, which may be embodied as a transmitter, a receiver and means for processing indications received from the serving base station (the eNodeB 12), whereby such indications comprise whether the serving base station does have or does not have an interface (an X2 interface) with another base station detected. When the indication indicates the presence of an interface the UE further comprises means for processing the indications received from the serving base station for population one of a first list (neighbor list) or a second list (candidate list) with identifications of the particular other base station detected. When the indication indicates no presence of an interface the UE further comprises means for processing the indications received from the serving base station for population of a third list (barred list) with identifications of the particular other base station detected. The indication received may comprise a base station identification and an indication of whether the base station is associated with a public network or a private network.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, it should be appreciated that at least some aspects of the exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention may not be limited for use with only this one particular type of wireless communication system, and that they may be used to advantage in other wireless communication systems having inter-base station interfaces through which, for example, handover-related information can be sent.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, note that the various interfaces (e.g., the X2 interface) may be referred to by other names. Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof

1-27. (canceled)

28. A method, comprising:
sending a serving base station an identification of at least one other base station;
receiving an indication from the serving base station that the serving base station does have or does not have an interface with the at least one other base station;
in response to the indication indicating that the serving base station does have an interface with the at least one other base station, populating one of a first list or a second list with the identification of the at least one other base station; and
in response to the indication indicating that the serving base station does not have an interface with the at least one other base station, populating a third list with the identification of the at least one other base station.

29. The method as in claim 28, wherein the first list comprises a neighbor list, the second list comprises a candidate list, and the third list comprises a barred list.

30. The method as in claim 28, wherein the indication is further indicative of a base station being associated with a public network or a private network.

31. The method as in claim 28, wherein the second list is ordered based on at least signal strength.

32. The method as in claim 28, wherein the second list is ordered based on at least privacy information.

33. The method as in claim 28, further comprising:
performing a suitability check on a base station in the second list;
in response to a particular base station being found to be suitable, adding an identification of the particular base station to the first list; and
in response to the particular base station being found to be not suitable, adding the identification of the particular base station to the third list.

34. A computer readable medium encoded with a computer program executable by a processor to perform actions comprising:
sending a serving base station an identification of at least one other base station;
receiving an indication from the serving base station that the serving base station does have or does not have an interface with the at least one other base station;
in response to the indication indicating that the serving base station does have an interface with the at least one other base station, populating one of a first list or a second list with the identification of the at least one other base station; and
in response to the indication indicating that the serving base station does not have an interface with the at least one other base station, populating a third list with the identification of the at least one other base station.

35. The computer readable medium encoded with a computer program of claim 34, wherein the first list comprises a neighbor list, the second list comprises a candidate list, and the third list comprises a barred list.

36. The computer readable medium encoded with a computer program as in claim 34, wherein the indication is further indicative of a base station being associated with a public network or a private network.

37. The computer readable medium encoded with a computer program as in claim 34, wherein the second list is ordered based on at least signal strength.

38. The computer readable medium encoded with a computer program as in claim 34, wherein the second list is ordered based on at least privacy information.

39. The computer readable medium encoded with a computer program as in claim 34, further comprising:
performing a suitability check on a base station in the second list;
in response to a particular base station being found to be suitable, adding an identification of the particular base station to the first list; and
in response to the particular base station being found to be not suitable, adding the identification of the particular base station to the third list.

40. An apparatus, comprising:
a transmitter configured to send a serving base station an identification of at least one other base station;
a receiver configured to receive an indication from the serving base station that the serving base station does have or does not have an interface with the at least one other base station;
a controller configured to respond to receipt of the indication that the serving base station does have an interface with the at least one other base station, and to populate one of a first list or a second list with the identification of the at least one other base station; and
said controller further configured to respond to receipt of the indication that the serving base station does not have an interface with the at least one other base station, and to populate a third list with the identification of the at least one other base station.

41. The apparatus as in claim 40, wherein the first list comprises a neighbor list, the second list comprises a candidate list, and the third list comprises a barred list.

42. The apparatus as in claim 40, wherein the indication is further indicative of a base station being associated with a public network or a private network.

43. The apparatus as in claim 40, wherein the second list is ordered based on at least signal strength.

44. The apparatus as in claim 40, wherein the second list is ordered based on at least privacy information.

45. The apparatus as in claim 40, further comprising:
said controller further configured to perform a suitability check on a base station in the second list;
said controller further configured to respond to a particular base station being found to be suitable, adding an identification of the particular base station to the first list; and
said controller further configured to respond to a particular base station being found to be not suitable, adding the identification of the particular base station to the third list.
